(19) United States
(12) Patent Application Publication
(10) Pub. No.: US 2026/0071762 A1
(43) Pub. Date: Mar. 12, 2026

(54) SURFACE GEOTHERMAL HEAT ENERGY CAPTURE AND STORAGE SYSTEM

(71) Applicant: Alan Keith Vowles, Devon (CA)

(72) Inventor: Alan Keith Vowles, Devon (CA)

(21) Appl. No.: 19/322,929

(22) Filed: Sep. 9, 2025

Related U.S. Application Data
(60) Provisional application No. 63/693,403, filed on Sep. 11, 2024.

(51) Int. Cl. F24D 15/04; E02F 5/10; F03G 4/00; F24D 18/00; F24D 101/80; F24S 10/00; F24T 10/00; F24T 10/10

(52) U.S. Cl. CPC F24D 15/04; E02F 5/10; F03G 4/035; F03G 4/037; F24D 18/00; F24T 10/10; F24D 2101/80; F24D 2200/11; F24D 2200/12; F24S 10/00; F24T 2010/53

(57) ABSTRACT

A geothermal system exchanges heat between a target and ground which receives geogenic heat from below. Heat exchange tubing in a continuous loop within the ground receives a circulated heat exchange fluid. An insulating layer spans over the ground with a greater footprint than the continuous loop in the ground below. The insulating layer may cover an area of land of at least 400 square metres and may be formed of a synthetic heat insulating material such as recycled plastic materials so that the insulting layer has a total R factor of 30 or greater. A heat pump is operable to transfer heat from the heat exchange tubing to the target for extracting the geogenic heat from the ground for heating the target in cold seasons, and transfer heat from the target to the heat exchange tubing for storing excess heat from the target to the ground in warmer seasons.

This application claims the benefit under 35 U.S.C. 119(e) of U.S. provisional application No. 63/693,403, filed Sep. 11, 2024.

### FIELD OF THE INVENTION

The present invention relates to a geothermal system, and a method of preparing ground, for the capture of heat from the prepared ground and the storage of heat in the ground.

### BACKGROUND

### History of Geothermal Heating Systems

Hot springs have been used for bathing since at least Paleolithic times. The oldest known spa is at the site of the Huaqing Chi palace. In the first century CE, Romans conquered Aquae Sulis, now Bath, Somerset, England, and used the hot springs there to supply public baths and underfloor. The admission fees for these baths probably represent the first commercial use of geothermal energy. The world's oldest geothermal district heating system, in Chaudes-Aigues, France, has been operating since the 15th century.

In 1892, the US's first district heating system in Boise, Idaho was powered by geothermal energy. It was copied in Klamath Fall, Oregon in 1900. The world's first known building to utilize geothermal energy as its primary heat source was the Hot Lake Hotel in Union County, Oregon, beginning in 1907. A geothermal well was used to heat green houses in Boise in 1926, and geysers were used to heat greenhouses in Iceland and Tuscany at about the same time. Charles Lieb developed the first downhole heat exchanger in 1930 to heat his house. Geyser steam and water began heating homes in Iceland in 1943.

In the 20th century, geothermal energy came into use as a generating source. Prince Piero Ginori Conti tested the first geothermal power generator on 4 Jul. 1904, at the Larderello steam field. It successfully lit four light bulbs. In 1911, the world's first commercial geothermal power plant was built there. It was the only industrial producer of geothermal power until New Zealand built a plant in 1958. In 2012, it produced some 594 megawatts.

### History of Heat Pumps

The heat pump was described by Lord Kelvin in 1853 and developed by Peter Ritter von Rittinger in 1855. Heinrich Zoelly had patented the idea of using it to draw heat from the ground in 1912.

After experimenting with a freezer, Robert C. Webber built the first direct exchange ground source heat pump in the late 1940s; sources disagree, however, as to the exact timeline of his invention. The first successful commercial project was installed in the Commonwealth Building (Portland, Oregon) in 1948, and has been designated a National Historic Mechanical Engineering Landmark by ASME. Professor Carl Nielsen of Ohio State University built the first residential open loop version in his home in 1948.

As a result of the 1973 oil crisis, ground source heat pumps became popular in Sweden and have been growing slowly in worldwide acceptance since then. Open loop systems dominated the market until the development of polybutylene pipe in 1979 made closed loop systems economically viable.

As of 2004, there are over a million units installed worldwide, providing 12 GW of thermal capacity with a growth rate of 10% per year. Each year (as of 2011/2004, respectively), about 80,000 units are installed in the US and 27,000 in Sweden. In Finland, a geothermal heat pump was the most common heating system choice for new detached houses between 2006 and 2011 with market share exceeding 40%.

### Harnessing of Geothermal Heat as a Practical Source of Renewable Energy

With Climate Change driving the need to lessen our dependence on fossil fuels; geothermal energy is seen as an environmentally clean and substantial source of renewable energy. Geothermal heat can be generally defined as a combination of radiogenic heat which is produced by the radioactive decay of isotopes in the earth's mantle and crust, and primordial heat which is the remnant heat produced from the ongoing cooling of the earth's core. This latent, deep earth heat continually migrates to the surface of the earth regardless of latitude or elevation. When the ground temperature is high enough; usually at depths in the range of 1 to 4 kilometers; this heat can be harnessed to produce electricity. At shallower depths in the range of 2 to 200 metres where ground temperatures range from 4 to 10 degrees Celsius in more northerly latitudes, this heat can be harnessed for practical use. The technology used to capture this shallow heat is referred to as a Geo-exchange system which uses a ground source heat pump to boost the ground temperature to practical levels in the order of 15-25 degrees Celsius.

It was not until the 1970s when the plastics revolution created polyethylene and polybutylene, both strong, flexible and durable pipe materials. Polyethylene and cross-linked polyethylene are now the only approved pipe materials for geo-exchange systems in most international jurisdictions. Ground source heat pumps are among the most energy-efficient heating systems using far less energy than can be achieved by burning fuels or using electric heaters. Efficiency is given as a coefficient of performance (CoP) which is typically in the range of 3 to 6, meaning that the devices output 3 to 6 KW of heat energy for each kW of electrical energy input.

Setup costs for geo-exchange systems are higher than for other heating systems due to the requirement to excavate large areas to install ground loops or drill bore holes. In colder climates, these costs are even larger due to the requirement for the ground loops to be deep enough to be protected from heat loss to the air and ground freeze during the cold season.

### SUMMARY OF THE INVENTION

According to one aspect of the invention there is provided a geothermal system for exchanging heat between a target and ground having an upper ground surface in which the ground receives geogenic heat from below, the system comprising:
heat exchange tubing arranged in a continuous loop placed in a region of the ground at a location spaced below the upper ground surface and receiving a heat exchange fluid circulated therein;
an insulating layer spanning the upper ground surface over said region of the ground such that the insulating layer covers an area of land of at least 400 square metres, the insulating layer being formed of a synthetic heat insulating material having a total R factor of 30 or greater;
a heat pump operable to transfer heat from the heat exchange tubing to the target for extracting the geogenic heat from the ground.

Preferably the heat pump is also operable to transfer heat from the target to the heat exchange tubing for storing heat in the ground.

According to a second aspect of the present invention there is provided a method of delivering heat from ground receiving geogenic heat from below to a target, the method comprising:
providing heat exchange tubing arranged in a continuous loop in a region of the ground at a location spaced below an upper ground surface of the ground;
providing an insulating layer spanning the upper ground surface over said region of the ground such that the insulating layer covers an area of land of at least 400 square metres, in which the insulating layer is formed of a synthetic heat insulating material having a total R factor of 30 or greater;
circulating a heat exchange fluid circulated within the continuous loop of heat exchange fluid; and
operating a heat pump to transfer heat from the heat exchange tubing to the target so as to transfer the geogenic heat from the ground to the target.

The use of an insulating layer above the heat exchange tubing in the ground minimizes heat loss to the air above so that the heat exchange tubing can be placed much closer to the surface of the ground while still effectively capturing considerable geogenic heat. This arrangement considerably reduces the cost and complexity associated with placement of heat exchanger loops deeper in the ground as would otherwise be required in colder climates.

Furthermore, the present invention solves one or more of the following fundamental problems: (i) Provides an environmentally clean source of heat-energy that is constant twenty-four hours a day, 365 days of the year, (baseload) unlike solar and wind which are intermittent. (ii) Provides a method of storage of both geothermal heat-energy and waste industrial heat which has been a fundamental problem with renewable energy sources. (iii) Provides a practical use for non-recyclable plastic waste that would otherwise end up in landfills. (iv) Converts low grade heat-energy to electricity.

The invention is designed to capture and/or store the constant, baseload geothermal heat-energy within the earth's crust (not to be confused with conventional geo-exchange systems which also rely on the seasonal, solar heat from the sun). The method by which this heat is captured may involve mechanically burying polyethylene pipe into the soil by means of trenching below the ground surface then covering the buried pipe with a layer of non-recyclable plastic insulation over a large area of land thereby preventing cold air from cooling and even freezing the ground.

This system relies solely on geothermal energy for heat and not heat from the sun. Since this geothermal heat-energy travels all the way to the surface of the earth; once the insulation is in place the heat can be captured and stored at the ground surface thereby eliminating the need for expensive excavation or drilling bore holes. Eliminating the high cost of excavation or drilling will be a factor in the economic viability of the proposed technology. Another factor which supports the economic viability is the fact that the one, time capital cost of the pipe and the insulation has a design life of greater than 75 years, compared to wind or solar arrays which have a design life of 15-20 years. Unlike wind and solar energy sources which are intermittent, geothermal energy is a constant (baseload) renewable energy source available 24 hours a day, 365 days of the year. The energy produced from sources such as wind and solar must be used as it is produced if it cannot be stored. Battery technology is still not a practical form of energy storage whereas the present invention provides a practical means of storing the heat-energy in the ground beneath the insulation which can be described as a type of giant battery.

As the geothermal heat makes its way to the earth surface it is prevented from escaping to the atmosphere by the layer of recycled plastic insulation which acts as a heat flow barrier. Due to the ability of the insulation to prevent heat from escaping, this heat capture method can also be used to store waste heat produced from industrial processes. One example of this waste industrial heat is the flaring or burning off of flammable gases at oil and gas production well sites.

Implementation of the present invention allows for multiple forms of land use. Soil for agriculture can be applied on top of the insulation and or buildings can be situated on top of the insulation which has high compressive strength.

Significant advances have been made with research and development in technologies such as the Stirling Engine and Organic Rankine Cycles. These technologies convert low grade heat to electricity. Heat pumps in the present invention may be coupled with a low-grade heat conversion technology to produce electricity. The advantage to converting heat-energy to electricity is that the energy can be transported long distances practically and economically in the form of electricity instead of in the form of low-grade heat.

The system may be used in combination with a generator operated as an organic Rankine cycle to convert low-grade heat to electricity.

The insulating layer preferably has an R factor of 50 or greater.

A thermal conductivity of the synthetic heat insulating material is at most 0.34 W/mk.

The synthetic heat insulating material is preferably a plastic material, for example a thermoset plastic material, or any non-recyclable plastic material destined for landfills.

The insulating layer is preferably porous so as to allow drainage of water therethrough.

The synthetic heat insulating material may be formed into bales in which the bales are supported adjacent one another in an array to form the insulating layer. The bales may be individually wrapped to prevent water penetration therein, in which the bales are positioned adjacent to one another to define drainage paths between the bales allowing drainage of water therethrough.

The insulating layer preferably extends laterally outward beyond a perimeter boundary of the heat exchange tubing about a full perimeter of the heat exchange tubing by a prescribed distance which is greater than a prescribed frost depth associated with the ground when the ground is uninsulated.

The heat exchange tubing extends primarily horizontally.

The continuous loop of the heat exchange tubing may define a first loop at a first distance from the upper ground surface and a second loop at a second distance from the upper ground surface which is greater than the first loop.

Preferably the heat exchange tubing is at a depth of greater than one foot below the upper ground surface.

The heat exchange tubing is at a depth below the upper ground surface that is less than a frost depth associated with the ground when the ground is uninsulated.

A thermal conductivity of said region of the ground locating the heat exchange tubing therein is preferably at least 1 W/mk.

The system may further include a layer of growing medium extending over the insulating layer, the growing medium having a depth arranged to support plant growth thereon.

According to another aspect of the present invention, there is provided a method of preparing ground for extraction of heat, in which the ground receives geogenic heat from below to a target, the method comprising:
providing heat exchange tubing arranged in a continuous loop in a region of the ground at a location spaced below an upper ground surface of the ground, the heat exchange tubing including a heat exchange fluid therein for circulation within the continuous loop;
providing an insulating layer spanning the upper ground surface over said region of the ground such that the insulating layer covers an area of land of at least 400 square metres, in which the insulating layer is formed of a synthetic heat insulating material having a total R factor of 30 or greater; and
providing a heat pump arranged to transfer heat from the heat exchange tubing to the target so as to transfer the geogenic heat from the ground to the target.

The method may further include providing a passive solar collector arranged to collect solar energy and use the collected solar energy to heat at least one of (i) the target, (ii) the heat exchanger fluid, and (iii) said region of the ground over which the insulating layer spans.

Placing the heat exchange tubing in the ground may be accomplished by (i) forming a furrow in the ground extending into the ground from the upper ground surface, (ii) placing the heat exchange tubing into the furrow, and (iii) closing the furrow.

The method may further include the steps of (i) excavating a layer of excavated earth from the ground up to an excavated level; (ii) placing the heat exchange tubing in the ground below the excavated level by placing the heat exchange tubing in said furrow; (iii) placing the insulating layer on the ground at the excavated level; and (iv) burying the insulating layer with the excavated earth from a previously excavated portion of the ground.

The above steps (i) to (iv) may be further accomplished in a single pass of a work vehicle in a continuous manner in which the earth being excavated from one section of ground in front of the vehicle is transferred rearwardly to bury insulating material placed on another section of ground immediately behind the work vehicle simultaneously with forming a trench and placement of the heat exchanger tubing in the trench by the work vehicle.

### BRIEF DESCRIPTION OF THE DRAWINGS

One embodiment of the invention will now be described in conjunction with the accompanying drawings in which:

FIG. 1 is a perspective view of entire surface geothermal heat capture and storage system.

FIG. 2 is an exploded perspective view of entire surface geothermal heat capture and storage system. exposing geothermal piping in soil at ground surface.

FIG. 3 is a cross section view physical test site showing insulation and drilled holes in which thermocouples were installed to record ground temperatures.

FIG. 4 is a cross-section view illustrating depth penetration of cold affected area from surface to the depth of constant ground temperature and the horizontal penetration limit.

FIG. 5 is a plan view illustrating entire area covered with insulation and showing the distance from the outer edge to the inner penetration limit of the cold affected zone.

FIG. 6 is a graph showing comparisons of the ground temperatures at surface beneath the insulation cover and at surface where there was no insulation and the ambient air temperature.

FIG. 7 is a schematic representation of a tractor with trenching assembly for laying geothermal pipe.

FIG. 8 is a schematic representation of the surface geothermal heat capture and storage system according to the first embodiment of FIG. 1, supplemented with heat collected by a passive solar heat collector.

In the drawings like characters of reference indicate corresponding parts in the different figures.

### DETAILED DESCRIPTION

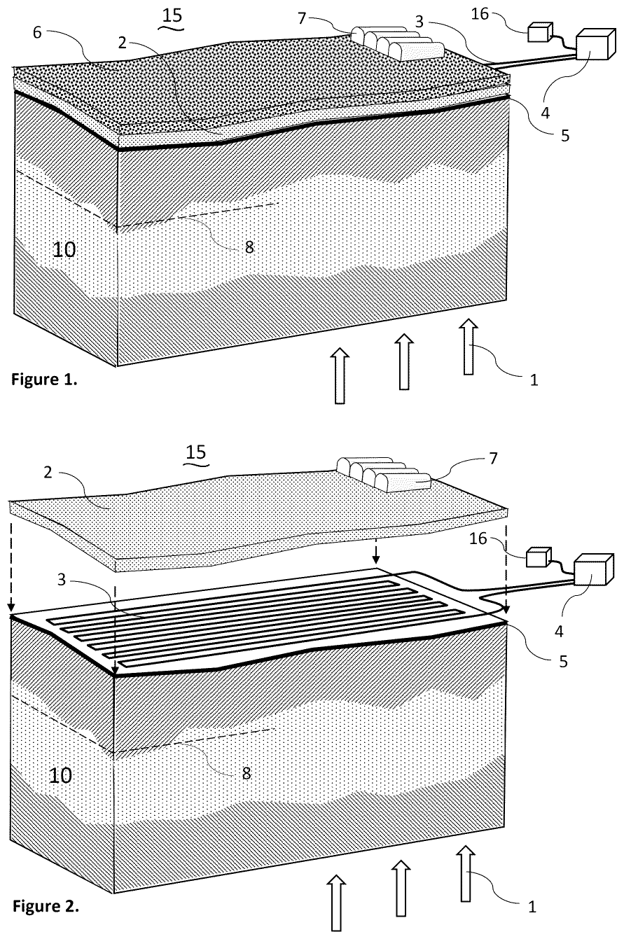

Preferred embodiments of the present invention are illustrated in FIGS. 1 and 2 which shows the geothermal or geogenic heat flux 1, more accurately defined as a combination of radiogenic heat which is produced by the radioactive decay of isotopes in the earth's mantle and crust, and primordial heat which is the remnant heat produced from the ongoing cooling of the earth's core. This latent, deep earth heat 1 continually migrates to the surface of the earth regardless of latitude or elevation above sea level. The technology used to capture the near surface heat is typically referred to as a Geo-exchange system which uses a ground source heat pump to boost the ground temperature to practical levels in the order of 15-25 degrees Celsius. At a depth 8 of 10-20 metres below the ground surface the temperature of the ground 10 remains almost constant year-round. The present invention provides a geothermal system and method for exchanging heat between a target 7 (to be heated or cooled) and ground having an upper ground surface in which the ground receives geogenic heat from below. The system includes a heat pump 4 that is operable in a first mode to transfer heat from the heat exchange tubing to the target for extracting the geogenic heat from the ground for operation in colder seasons, and in a second mode to transfer heat from the target to the heat exchange tubing for cooling the target and storing heat in the ground for operation in warmer seasons.

By installing an insulating barrier 2, as shown in FIGS. 1 and 2 the present invention captures and stores the shallow geothermal heat 1 as it reaches the ground surface and is prevented from escaping to the atmosphere 15. The insulating layer spans the upper ground surface over a region of the ground that locates heat exchange tubing 3 of the system therein as described below. The insulating layer covers an area of land of at least 400 square metres and is formed of a synthetic heat insulating material having a total R factor of 30 or greater, and more preferably a total R factor of 50 or greater. The synthetic heat insulating material is typically a plastic material, for example a thermoset plastic material, or another a non-recyclable plastic waste material otherwise destined for landfills.

The waste plastic material may be prepared for use as an insulating layer by shredding or breaking up the waste plastic such that it can be baled or bagged into bundles or bales 22 that can be stacked adjacent to one another in an array to form the continuous layer 2 of the insulating material. Even when baled, the resulting bales 22 can be wrapped with a waterproof boundary material 23 to form a substantially waterproof bundle similarly to the bagged material. The plastic material within the boundary material may be shredded strands of material with air gaps between the strands in which the air gaps are maintained dry due to the boundary material 23. When the bales 22 are placed adjacent one another in a two dimensional array forming the continuous layer 2, the seams between adjacent bundles or bales define drainage paths extending between the top and bottom sides of the insulating layer such that drainage is permitted downwardly through the insulating layer 2 while maintaining the insulating material within the interior of the bales substantially dry. Even when the insulating layer 2 is formed of continuous sheet material such as rigid foam insulating sheets or blocks, the sheet material may include spaced apart drainage apertures such that the insulating layer is again porous to allow drainage of water from precipitation and the like therethrough.

Continuous lengths of polyethylene pipe 3 are trenched into the uppermost ground layer 5 either singularly or in plurality at different depths below the ground surface with trenching machinery which in turn covers the pipe 3. The pipe 3 is connected at opposite ends in a closed loop configuration to a geothermal heat pump 4 and a heat exchange fluid which is resistant to freezing is circulated through the pipe 3 and the heat pump 4. The upper soil layer 5 typically has a relatively high thermal conductivity of greater than 1.0 W/mK which facilitates the transfer of heat between the pipe 3 and the ground below. The next stage of the process is to spread a layer of non-recyclable waste plastic 2 over the area where the pipe 3 has been buried. The waste plastic forming the insulating layer 2 will have a low thermal conductivity of less than 0.34 W/mK which acts as a thermal insulator and does not allow for significant heat loss thereby acting as a barrier and preventing heat from escaping to the atmosphere 15.

The pipe 3 is a heat exchange tubing arranged in a continuous loop placed in a region of the ground at a location spaced below the upper ground surface and receiving a heat exchange fluid circulated therein. The heat exchange tubing or pipe 3 extends primarily horizontally within the ground, at a depth of greater than one foot, and more preferably greater than 3 feet from the upper ground surface, while having a depth that is less than the prescribed frost depth associated with the adjacent uninsulated ground. However, the horizontal area or footprint covered by the loop of pipe 3 is less than the corresponding horizontal area or footprint of the insulating layer such that the insulating layer 2 extends laterally outward beyond a perimeter boundary of the heat exchange tubing about a full perimeter of the heat exchange tubing by a prescribed distance which is greater than the prescribed frost depth associated with the adjacent uninsulated ground. In this manner, frost is prevented from penetrating into the ground to reach the heat exchanger tubing even when the tubing is above the frost depth.

In some embodiments, the tubing or pipe 3 can be placed at a single depth, however, in preferred embodiments, the pipe 3 can be placed at different depths. For example, the continuous loop of the heat exchange tubing may define a first loop lying horizontally at a first distance from the upper ground surface and a second loop lying horizontally at a second distance from the upper ground surface which is greater than the first loop

A final step in the process is to spread a layer of high nutrient growing medium 6 produced from a combination of recycled organic waste and biochar or materials such as humalite. The growing medium 6 has a suitable depth arranged to support plant growth thereon, for example a depth greater than one foot.

In some embodiments of the present invention, the heat pump 4 is coupled with a low-grade heat conversion technology 16 such as, but not limited to, a Stirling Engine or Organic Rankine Cycle system which converts the low-grade heat-energy to electricity.

The heat collected from the ground in cold seasons can be used by the heat pump 4 for heating a target 7 such as a building for occupants or a greenhouse for agriculture for example. Alternatively, in warmer seasons, excess heat from the target 7 can be pulled from the target by the heat pump 4 for storing the heat in the ground using the heat exchange fluid circulated in the continuous loop of heat exchange tubing 3.

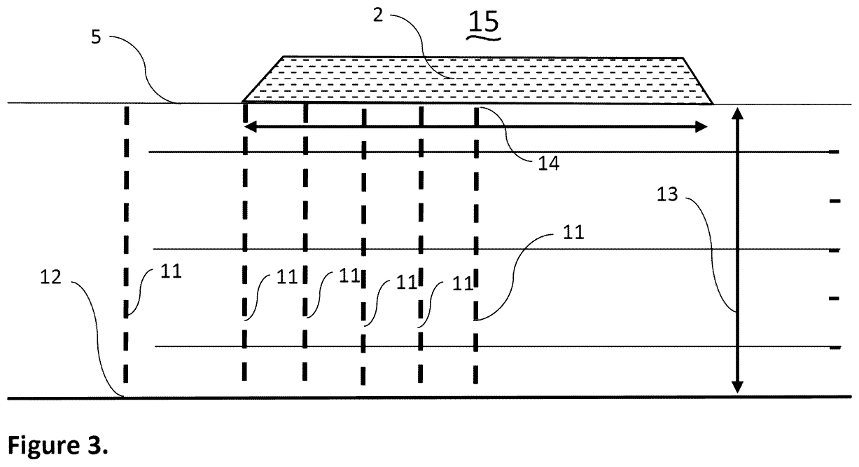

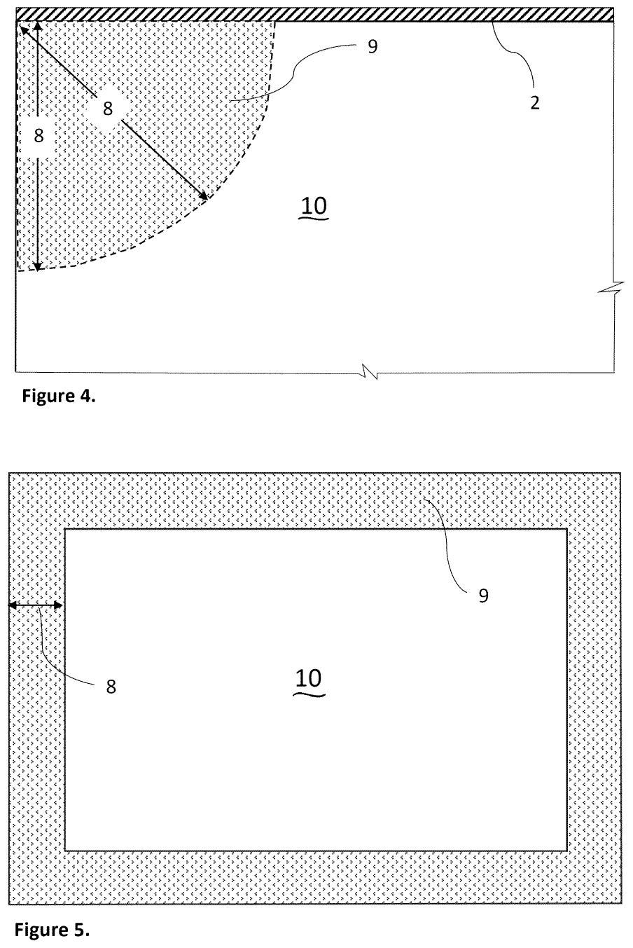

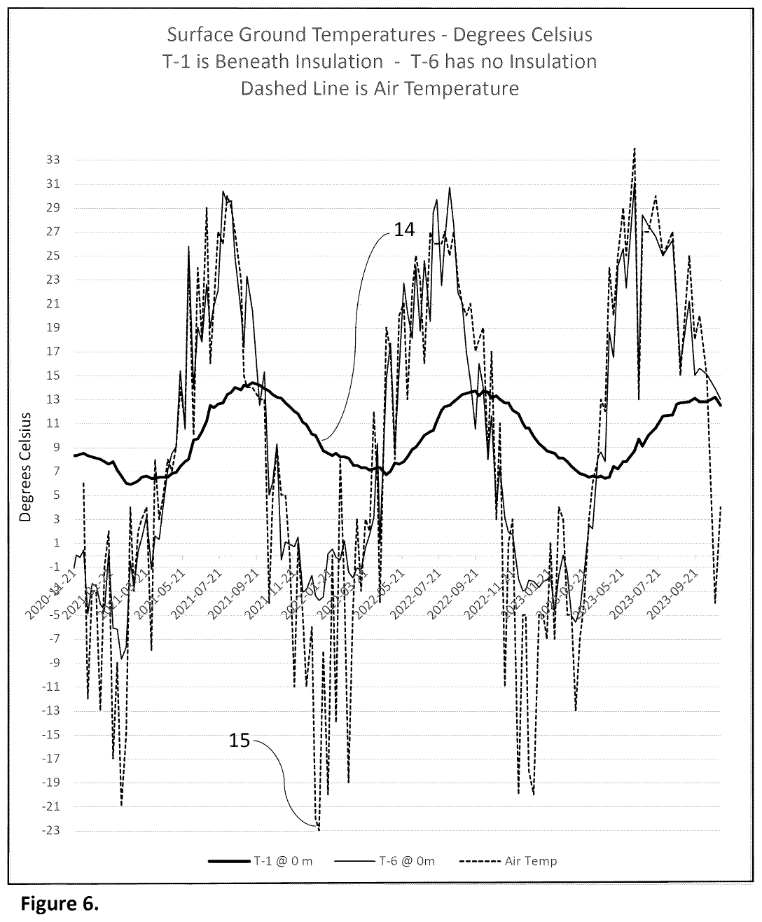

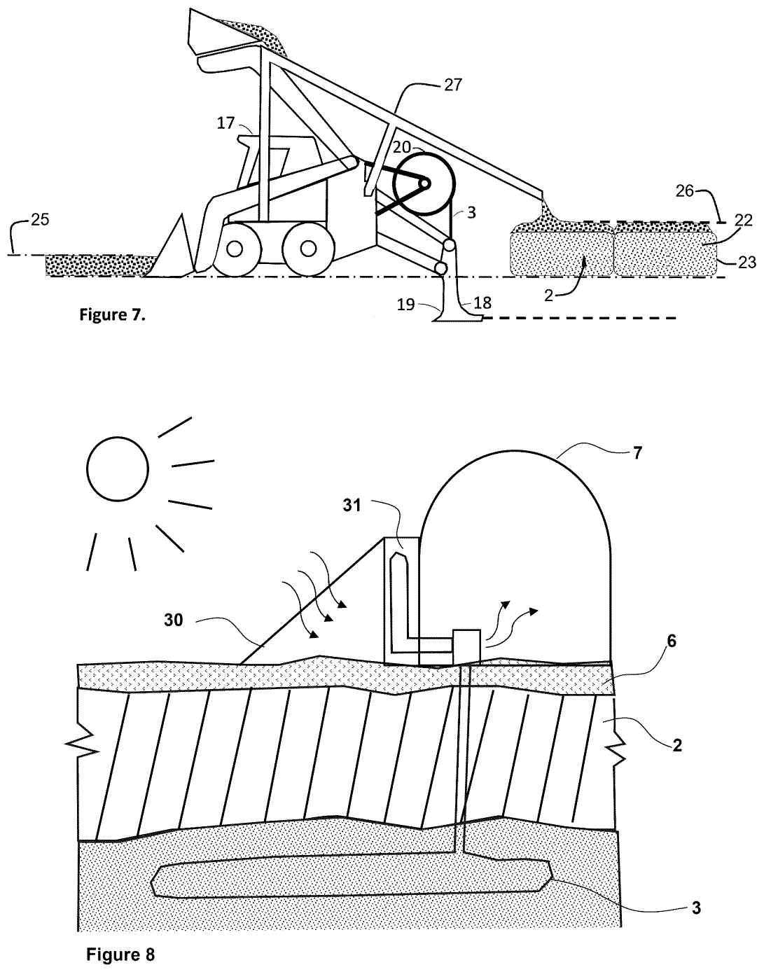

In the province of Alberta, Canada a physical experiment was conducted over a three, year period whereby a large area of ground was insulated. As shown in FIGS. 3, 4 and 5, holes 11 were drilled down to the water table 12 at a depth of 5.8 metres 13. Temperature data was collected at the ground surface 5 and at the water table 12 in six holes. It was learned that there is a zone affected by the cold 9 that reaches from the ground surface 5 to the depth 8 of the constant ground temperature 10. The cold affected zone 9 extends both vertically and horizontally. As shown on FIG. 5, the extent 8 of the cold affected zone 9 which means that regardless of how large an area is insulated the extent 8 of the cold affected zone 9 remains the same. Therefore, the ground surface temperature 14 will remain constant throughout the area 10 which lies beyond the cold affected zone.

Without the insulation barrier 2 in place, the geothermal heat flux 1 is interrupted and minimized as it comes in contact with the cooler ground during the colder months in northern climates thereby allowing the ground to cool. Conversely, with the insulation barrier in place the geothermal heat flux 1 is not minimized as it travels all the way to the ground surface thereby preventing the near surface ground from freezing during the colder months. On Jan. 3, 2022 when the temperature of the surrounding atmosphere 15 was −23 degrees Celsius, the temperature at the ground surface 14 at the centre of the insulation 2 was recorded at +9.4 degrees Celsius confirming that the insulation effectively prevented the cold, winter air from freezing the ground. The average ground temperature during the seven coldest months of the year over a two-year period was 9.5 degrees Celsius. As the geothermal heat flux 1 flows toward the earth surface the temperature normally decreases, however when an insulation layer is applied on the ground surface the rate of heat transfer to the environment is reduced resulting in an increase in temperature. The principle behind this phenomenon is described in Fourier's Law of Heat Conduction and in the First Law of Thermodynamics. This law, also known as the Law of Energy Conservation, states that the energy added to the system (in this case, heat) will increase the internal energy of the material, leading to a rise in temperature.

According to one preferred embodiment, the method used to prepare the ground and bury the geothermal pipe 3 involves use of a work vehicle 17 such as a tractor equipped with a ripper 19 or a plurality of rippers and a continuous feed trenching assembly 18. The ripper 19 cuts a trough or furrow in the ground while the geothermal pipe 3 is fed into the trough by means of a trenching assembly 18 which draws the geothermal pipe 3 off a pipe reel 20 which is mounted on an upper and/or rear portion of the vehicle 17. As the geothermal pipe 3 is fed into the trough, a packer assembly such as a blade or packer wheel of the trenching assembly 18 covers the geothermal pipe 3 with soil. In this instance, the method of the present invention may further include the steps of placing the heat exchange tubing in the ground by (i) forming a furrow in the ground extending into the ground from the upper ground surface, (ii) placing the heat exchange tubing into the furrow, and (iii) closing the furrow to bury the tubing in the ground at a prescribed depth of the furrow.

More particularly, the work vehicle 17 may be an excavator that includes a typical bucket or excavator blade forwardly of the vehicle to remove a layer of excavated earth from the ground so that the original grade 25 of the ground is lowered to a lower excavated level. The vehicle 17 travels on the lowered excavated level and uses the furrow opener or ripper 19 to trench or furrow further into the ground below the excavated layer for laying the heat exchange tubing 3 into the furrow or trench in a single pass below the excavated layer while excavating. The same work vehicle or an additional support vehicle may travel alongside or with the vehicle 17 which carries the bales 22 of insulating material and lays the bales onto the excavated layer after the pipe or tubing 3 has been trenched into the ground. The vehicle 17 in the illustrated embodiment is further provided with a conveyor assembly 27 which transfers the excavated earth from the excavation in front of the vehicle, rearwardly to be deposited onto the bales placed on the excavated level. The conveyed excavated earth placed over the bales forms the growing medium layer 6 described above, having a new grade 26. The final new grade 26 is generally spaced above the original grade by the height of the bales 22 of the insulating layer. The entire process of excavating earth, placing the heat exchange tubing 3 into the ground, placing the bales, and depositing the excavated earth over the bales to bury the insulating layer with the excavated earth from a previously excavated portion of the ground, occurs with a single pass of the work vehicle over the ground.

Turning now to FIG. 8, the system of FIGS. 1 and 2 may further cooperate with a passive solar collector 30. The passive solar collector comprises an enclosed chamber having a sloped exterior wall formed primarily of windows of transparent or translucent material through which solar rays can pass to heat the interior of the chamber. A rear wall of the chamber, opposite the sloped exterior wall onto which the solar rays are directed comprises a heat sink 31 which may be form of heat conductive material that is dark in color to absorb as much solar energy and heat as possible. A circuit of heat exchanger fluid passing through the heat sink 31 transfers the collected solar energy as heated fluid to at least one of (i) the target building 7, (ii) the heat exchanger fluid in the heat exchange tubing 3, and/or (iii) the region of ground that is insulated by the layer 2 and which receives the heat exchange tubing 3 therein. In the illustrated embodiment, the heat exchange fluid circuit of the heat sink 31 may be in heat exchanging relation with a heat exchange tubing 3 such that the heat exchange fluid can be heated by the passive solar collector to store more heat in the ground. Alternatively, the heat exchange fluid circuit of the heat sink 31 may extend into the ground to directly heat the ground about the heat exchange tubing 3 for storing more heat in the ground in warm seasons. When the solar collector forms a common structure with the target building 7 to be heated as illustrated, the heat exchange fluid circuit of the heat sink 31 can also be used to supply heat to the heat pump 4 for heating the building in part from the solar collector to supplement heat drawn from the ground loop of tubing 3, particularly in cold seasons.

The concept behind the present invention was conceived when the author conducted an experiment to capture the geogenic heat within the earth's crust to provide a heat source for a commercial greenhouse. Through his profession as a geophysicist the author had an understanding of geothermal gradients and the knowledge that geogenic heat travels all the way to the surface of the earth regardless of the air temperature, the latitude or the elevation above sea level. To demonstrate the concept behind the present invention he drilled a series of holes down to the water table at a depth of 5.8 metres. Thermocouples were installed in the top and bottom of each hole to enable collection of ground temperature data. The area above the holes was then covered with a thick layer of insulation with a total R factor of approximately 70. Temperature data was collected each week over a period of three years. Throughout the seven coldest months of the year for two consecutive years the ground surface temperature beneath the centre of the insulation cover averaged 9.5 degrees Celsius. Where there was no insulation, the ground was frozen to a depth of at least 0.5 metres.

From the ground temperature data gathered at the physical test site and from air temperatures based on historical temperature data recorded by Environment Canada, one can determine the amount of heat-energy that will be produced at a specific site per unit area, using the formula below. The average temperature beneath the insulation throughout the seven coldest months of the year over two years the ground surface temperature is 9.5 degrees (the hot side of the heat flow formula). This temperature is based on readings taken weekly throughout the period. The average air temperature during the coldest seven months of the year is −4.9 degrees C. (the cold side of the heat flow formula.) The temperature difference between the hot and cold sides is therefore 14.4 degrees C. The thickness is based on the amount of waste plastic insulation required for an insulation R-factor of at least R-70.

Rate of heat flow expressed in Watts (joules per second) is:

$$Q / Δ t = kA Δ T / Δ x$$

where Q is the net heat (energy) transfer, Δ t is the time taken (24 hours or 86,400 seconds, k is the thermal conductivity expressed in W/mK, A is the surface area of the surface emitting heat, ΔT is the difference in temperature between the hot and cold sides, and Δx is the thickness of the material conducting heat (distance between hot and cold sides).

The following are used as input values: Δt=86400 seconds (24 hours); k=0.2 W/mK−the average thermal conductivity used for waste plastic; A=505.5 sq. metres (⅛ acre) area required for a conventional geo-exchange system; T=14.4 degrees C. which is the temperature difference between the hot and cold sides; and x=1.5 metres, the thickness in metres of waste plastic insulation.

The input values produce the following results:

$$Q / 86 , 400 = 0.2 \times 505.5 \times 14.4 / 1.5 = 970.5 Watts ( 0.971 kW )$$

$$Q = 970.5 \times 86400 = 83 , 851 , 200 joules = 23.29 kW hours per day .$$

$$Energy = 0.971 kW \times 24 hours = 23.3 kW hours per day .$$

$$Heat flow = 970.5 Watts / 505.5 sq m = 1.92 W / m 2 or 1920 mW / {m}^{2} .$$

Since various modifications can be made in the invention as herein above described, and many apparently widely different embodiments of same made, it is intended that all matter contained in the accompanying specification shall be interpreted as illustrative only and not in a limiting sense.

1. A geothermal system for exchanging heat between a target and ground having an upper ground surface in which the ground receives geogenic heat from below, the system comprising:
heat exchange tubing arranged in a continuous loop placed in a region of the ground at a location spaced below the upper ground surface and receiving a heat exchange fluid circulated therein;
an insulating layer spanning the upper ground surface over said region of the ground such that the insulating layer covers an area of land of at least 400 square metres, the insulating layer being formed of a synthetic heat insulating material having a total R factor of 30 or greater;
a heat pump operable to transfer heat from the heat exchange tubing to the target for extracting the geogenic heat from the ground.

2. The system according to claim 1 wherein the heat pump is operable to transfer heat from the target to the heat exchange tubing for storing heat in the ground.

3. The system according to claim 1 in combination with a generator operated as an organic Rankine cycle to convert low-grade heat to electricity.

4. The system according to claim 1 wherein the insulating layer has an R factor of 50 or greater.

5. The system according to claim 1 wherein a thermal conductivity of the synthetic heat insulating material is at most 0.34 W/mk.

6. The system according to claim 1 wherein the synthetic heat insulating material is a plastic material.

7. The system according to claim 1 wherein the insulating layer is porous so as to allow drainage of water therethrough.

8. The system according to claim 1 wherein the synthetic heat insulating material is formed into bales and wherein the bales are supported adjacent one another in an array to form the insulating layer.

9. The system according to claim 8 wherein the bales are individually wrapped to prevent water penetration therein and wherein the bales are positioned adjacent to one another to define drainage paths between the bales allowing drainage of water therethrough.

10. The system according to claim 1 wherein the insulating layer extends laterally outward beyond a perimeter boundary of the heat exchange tubing about a full perimeter of the heat exchange tubing by a prescribed distance which is greater than a prescribed frost depth associated with the ground when the ground is uninsulated.

11. The system according to claim 1 wherein the heat exchange tubing extends primarily horizontally.

12. The system according to claim 11 wherein the continuous loop of the heat exchange tubing defines a first loop at a first distance from the upper ground surface and a second loop at a second distance from the upper ground surface which is greater than the first loop.

13. The system according to claim 1 wherein the heat exchange tubing is at a depth of greater than one foot below the upper ground surface.

14. The system according to claim 1 wherein the heat exchange tubing is at a depth below the upper ground surface that is less than a frost depth associated with the ground when the ground is uninsulated.

15. The system according to claim 1 wherein a thermal conductivity of said region of the ground locating the heat exchange tubing therein is at least 1 W/mk.

16. The system according to claim 1 further comprising a layer of growing medium extending over the insulating layer, the growing medium having a depth arranged to support plant growth thereon.

17. A method of preparing ground for extraction of heat, in which the ground receives geogenic heat from below to a target, the method comprising:
providing heat exchange tubing arranged in a continuous loop in a region of the ground at a location spaced below an upper ground surface of the ground, the heat exchange tubing including a heat exchange fluid therein for circulation within the continuous loop;
providing an insulating layer spanning the upper ground surface over said region of the ground such that the insulating layer covers an area of land of at least 400 square metres, in which the insulating layer is formed of a synthetic heat insulating material having a total R factor of 30 or greater; and
providing a heat pump arranged to transfer heat from the heat exchange tubing to the target so as to transfer the geogenic heat from the ground to the target.

18. The method according to claim 17 further comprising providing a passive solar collector arranged to collect solar energy and use the collected solar energy to heat at least one of (i) the target, (ii) the heat exchanger fluid, and (iii) said region of the ground over which the insulating layer spans.

19. The method according to claim 17 further comprising:
placing the heat exchange tubing in the ground by (i) forming a furrow in the ground extending into the ground from the upper ground surface, (ii) placing the heat exchange tubing into the furrow, and (iii) closing the furrow.

20. The method according to claim 19 further comprising:
excavating a layer of excavated earth from the ground up to an excavated level;
placing the heat exchange tubing in the ground below the excavated level by placing the heat exchange tubing in said furrow;
placing the insulating layer on the ground at the excavated level; and
burying the insulating layer with the excavated earth from a previously excavated portion of the ground.
